(19) United States
(12) Patent Application Publication
(10) Pub. No.: US 2025/0093026 A1
(43) Pub. Date: Mar. 20, 2025

(54) FLAME TUBE FOR IMPROVED UNIFORMITY OF THE RADIANT TUBE TEMPERATURE

(71) Applicant: Honeywell International Inc., Charlotte, NC (US)

(72) Inventors: Heinz-Peter Gitzinger, Neuss (DE); Kiran Ambilpur, Hyderabad (IN); Sebastian Escher, Osnabrück (DE); Matthias Rieken, Osnabrück (DE); Sandra Runde, Mettingen (DE); Lars Schroeder, Borgholzhausen (DE)

(21) Appl. No.: 18/368,390

(22) Filed: Sep. 14, 2023

(51) Int. Cl. F23D 14/12; F23D 14/70

(52) U.S. Cl. CPC F23D 14/125; F23D 14/70

(57) ABSTRACT

A radiant heating tube device with a fuel-heated burner and a flame tube located inside the radiant heating tube often shows an undesirable increase in temperature in the area of the closed end of the radiant tube. This temperature rise can be reduced by installing an additional tube or other flow body in the area of the end of the flame tube. This achieves a more uniform radiant tube surface temperature.

### TECHNICAL FIELD

Embodiments are generally related to industrial furnaces and radiant tubes used in such furnaces. Embodiments further relate to the optimization of radiant tube heating systems.

### BACKGROUND

Radiant heating tubes, often called “radiant tubes,” are employed in industrial furnaces to ensure that the materials inside the heating chamber remain isolated from the exhaust gases produced during combustion or when special heat treatment conditions are needed, such as creating a carburizing atmosphere. The exhaust gases typically contain residual oxygen, water vapor, and/or CO2, and these elements can potentially cause oxidation in different materials.

For example, in order to avoid oxidation or scale formation of the material to be treated during the heat treatment of metals, it may be necessary to prevent contact of the product with the exhaust gases of combustion. This can be achieved with radiant tubes due to the fact that combustion takes place inside the radiant tube closed to the heating chamber and the exhaust gases from combustion are not fed into the heating chamber. The interior of the radiant tube thus represents the combustion chamber. The material to be treated and the radiant tubes for heating can be arranged in the heating chamber.

A high quality heat treatment requires the product to have a uniform temperature. This means that the temperature of the radiant tube surface should be as uniform as possible and be positioned at a sufficiently large distance from the material to the radiant tubes. In the case of uneven temperature distribution on the radiant tube surface, a greater distance between the material and the radiant tubes can be required to compensate for this. Large distances require larger furnace designs and thus make furnace construction and heat treatment more expensive.

### BRIEF SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

It is, therefore, one aspect of the embodiments to provide for an improved radiant tube for use in industrial furnaces.

It is another aspect of the embodiments to provide for a radiant tube in which undesirable increases in temperature are reduced.

It is a further aspect of the embodiments to improve the temperature uniformity of the radiant tube surface of fuel-heated radiant tubes, in particular one-sided closed shell radiant heating tubes with internal flame tubes.

It is also an aspect of the embodiments to provide for a method, apparatus and system that can reduce an increase in temperature at the radiant tube surface in the area of the end of the inner flame tube opposite the burner in a radiant tube configuration.

The aforementioned aspects and other objectives can now be achieved as described herein. In an embodiment, a radiant tube apparatus, can include a burner and an inner flame tube, and at least one flow body installed in an area at an end of the inner flame tube opposite the burner.

In an embodiment of the radiant tube apparatus, the at least one flow body can be tubular.

In an embodiment of the radiant tube apparatus, the at least one flow body can protrude into the flame tube.

In an embodiment of the radiant tube apparatus, the at least one flow body can protrude into the flame tube with a length of, for example, approximately 0 to 1× diameter of the flame tube.

In an embodiment of the radiant tube apparatus, the at least one flow body protrudes into the flame tube with a length of, for example, approximately 0.3 to 0.7× diameter.

In an embodiment of the radiant tube apparatus, the at least one flow body can be arranged in an area at an end of radiant tube apparatus without overlap.

In an embodiment of the radiant tube apparatus, the at least one flow body can comprise a polygonal tube-like body.

In an embodiment of the radiant tube apparatus, the at least one flow body can comprise an arrangement of a plurality of polygonal tube-like bodies.

In an embodiment of the radiant tube apparatus, each polygonal tube-like body among the plurality of polygonal tube-like bodies can be located next to each other, behind each other, or inside each other.

In an embodiment of the radiant tube apparatus, a plurality of flow bodies for the displacement of flow can include the at least one flow body, such that the flow bodies among the plurality of flow bodies are individually or mostly partially or completely closed therein.

In an embodiment, a radiant tube apparatus, can include a burner and an inner flame tube, and at least one flow body installed in an area at an end of the inner flame tube opposite the burner, wherein the at least one flow body is tubular and protrudes into the flame tube.

In an embodiment, a radiant tube heating system can include a plurality interlocking tubes with different diameters and a specific geometry, wherein the plurality of interlocking tubes is configured to mitigate an undesirable increased temperature at the radiant tube end of a radiant tube.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the principles of the embodiments.

FIG. 1 illustrates an example of the construction of a fuel-heated radiant heating tube, with an outer radiant tube, a burner, and an inner flame tube;

FIG. 2 illustrates an exemplary and schematic temperature distribution of the surface of a fuel-fired radiant tube;

FIG. 3 illustrates a schematic diagram of the flow in the area of the end of the inner flame tube opposite the burner in a radiant tube, in accordance with an embodiment;

FIG. 4 illustrates a schematic diagram of an example of the flow in the area of the end of the inner flame tube opposite the burner with an additionally installed tube in a radiant tube, in accordance with an embodiment;

FIG. 5 illustrates a schematic diagram of an example of a radiant tube with three additionally installed interlocking tubes in the radiant tube, in accordance with an embodiment; and

FIG. 6 illustrates a schematic diagram of an example radiant tube with additionally installed not interlocking tubes in the radiant tube, in accordance with an embodiment.

Identical or similar parts or elements in the figures and detailed description may be indicated by the same reference numerals.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other issues, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

Throughout the specification and claims, terms may have nuanced meanings suggested or implied in context beyond an explicitly stated meaning. Likewise, phrases such as “in an embodiment” or “in one embodiment” or “in an example embodiment” and variations thereof as utilized herein may or may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. Furthermore, the term “at least one” as used herein, may refer to “one or more.” For example, “at least one widget” may refer to “one or more widgets.”

In addition, the term “based on” may be understood as not necessarily intended to convey an exclusive set of factors and may, instead, allow for existence of additional factors not necessarily expressly described, again, depending at least in part on context.

A radiant heating tube device with a fuel-heated burner and a flame tube located inside the radiant heating tube often shows an undesirable increase in temperature in the area of the closed end of the radiant tube. This temperature rise can be reduced by installing an additional tube or other flow body in the area of the end of the flame tube. This achieves a more uniform radiant tube surface temperature.

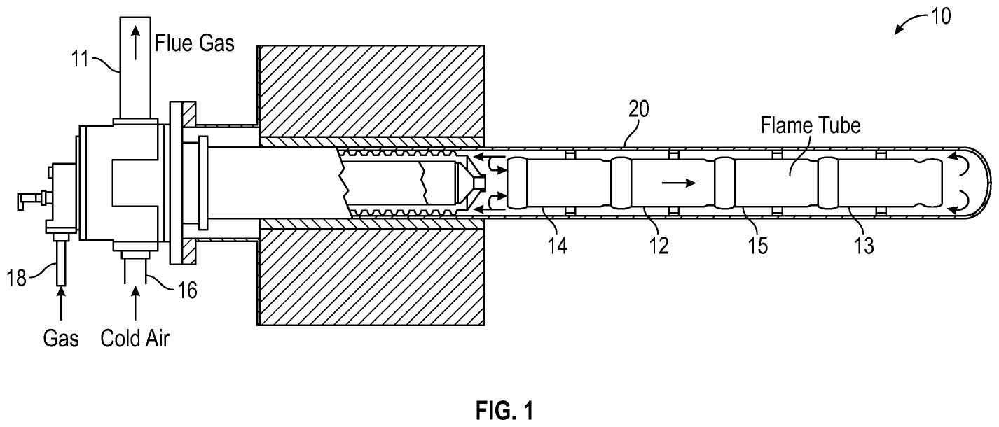

FIG. 1 illustrates a side cut-away view depicting an example of the construction of a fuel-heated radiant heating tube 10 with an outer radiant tube 20, a burner, and an inner flame tube. The radiant tube heating system 10 shown in FIG. 1 can include one or more interlocking inner tubes such as, for example, inner tubes 13, 15, 12, 14. The configuration shown in FIG. 1 includes an inlet 16 for cold air and an outlet 11 for flue gas. An inlet 18 for gas is also shown in FIG. 1 to the left of the inlet 16.

A non-limiting example of a radiant tube heating system, which may be adapted for use in accordance with an embodiment is a self-recuperative burner such as the ECOMAX® burner in which combustion air is preheated by the exhaust heat via a heat exchanger integrated in the burner and can involve indirect heating with single-ended radiant heating tubes. In this application, the exhaust gases can be generally routed past the heat exchanger of the burner. The exhaust gas temperature drops, owing to use of the exhaust gas heat to preheat the combustion air and the exhaust gas losses are thus reduced which means that firing efficiency may be increased.

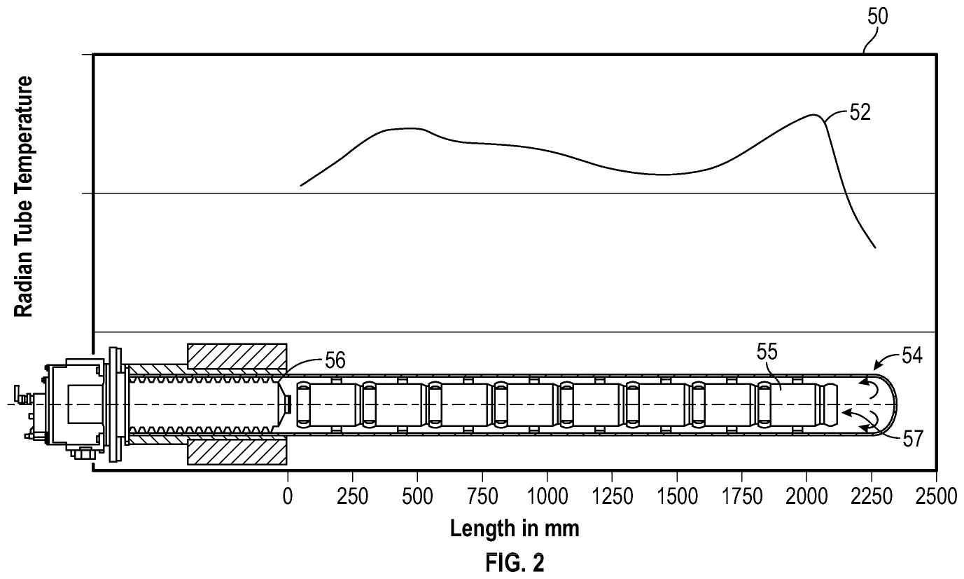

FIG. 2 illustrates a diagram depicting an example fuel-fired radiant tube 54 and an associated graph 50 of a radiant tube temperature, in accordance with an embodiment. That is, FIG. 2 depicts an exemplary and schematic temperature distribution 52 (as shown in graph 50) of the surface of the fuel-fired radiant tube 54. This demonstrates that at least one goals of the embodiments involves reducing the increase in temperature at the radiant tube surface in the area of the end 57 of the inner flame tube opposite the burner 56.

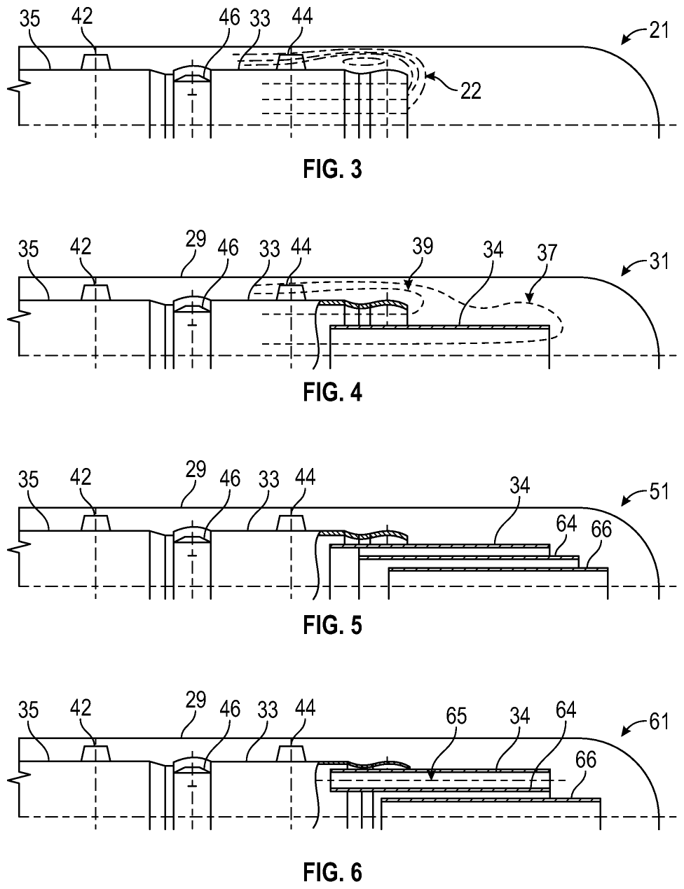

Note that the fuel-fired radiant tube 54 shown in FIG. 2 is an example of a radiant tube which may be implemented in accordance with an embodiment. It should be appreciated, however, that variations in the design of configuration of the fuel-fired radiant tube 54 may be implemented in accordance with alternative embodiments as shown and described herewith, for example, with respect to FIGS. 3 to 6.

FIG. 3 illustrates a side cut-away view of a radiant tube 21 depicting the flow in the area at the end of an inner flame tube opposite a burner (not shown in FIG. 3) of the radiant tube 21. The deflection of the flow in FIG. 3 can take place concentrated in a narrow area. This and the strong deflection in this area can result in increased convective heat transfer to the outer radiant tube. Note that in FIG. 3, the dashed flow lines 22 illustrate the pathway of the flow.

The task of equalizing the radiant tube temperature can be achieved by reducing the increase in heat transfer in the area of the end of the flame tube in such a way that at least one additional tube or a flowable body is placed in the area of the end of the flame tube.

In FIG. 3 to FIG. 6, support feet 42 and 44 are depicted (e.g., 4x 90° around of the flame tube elements), which can be used in some embodiments to position the flame tube in the middle of the radiant tube. Furthermore, a bayonet connection 46 of two flame tube elements may be implemented in some embodiments. It should be appreciated that the use of components such as the support 42 and 44 and/or the bayonet connection 46 are optional and may not be required in an embodiment. As a reminder in the various figures depicted and discussed herein, identical or similar parts or elements.

In FIG. 4, a side cut-away view of a radiant tube 31 with optimized flow in the area of the end of the inner flame tube opposite the burner by an additionally installed tube 34 close to the end of the inner flame tube 33 is depicted, in accordance with an embodiment. The deflection of the flow is no longer concentrated but distributed over two sub-areas and in a wider area. As a result, the convective heat transfer is less amplified and more distributed in the area of the nozzle end to the outer radiant tube. Note that in FIG. 4, the dashed flow lines 37 and 39 illustrate the pathway of the flow.

The additional tube 34 incorporated into the inner flame tube may protrude into the flame tube in one embodiment; preferably with a length of, for example, 0 to 1× diameter of the flame tube; preferably with a length of 0.5× diameter. In another embodiment, the tube incorporated into the inner flame tube may also be located in the area of the end of the flame tube without overlap. Preferably subsequently, or at a small distance from the flame tube, with a length of 0 to 0.5× diameter.

Instead of an additional tube to be installed in the flame tube, an additional flow body with the intended geometry can also be installed in an embodiment. Such a flow body can be a round or polygonal tube-like body or arrangement of several such bodies. In an embodiments, an arrangement of such bodies can be carried out next to each other, one behind the other or inside each other. In order to displace the flow, the flow bodies can be partially or completely closed on the inside to displace the flow. For example, instead of a pipe, a flow body can also be designed as a closed, round or polygonal cylinder. In this case, the exhaust gas does not flow through the flow body but flows around it.

The radiant tube shown in FIG. 4 can be cylindrically shaped and can include a plurality of inner tubes, including, but not limited to inner tubes 33, 35, 34, etc. The additional inner tube 34 is shown in FIG. 4 as contained at least partially within the inner tube 33 with a portion of the inner tube 34 extending or jutting outward from the inner tube 33. Note that the radiant tube end of the radiant tube shown in FIG. 4 can contain at least the inner tubes 35, 33 and 34. The radiant tube can include an outer tube 29 and one or more inner tubes such as the tubes 33 and 35.

It should be appreciated that although only tubes 33 and 35 are shown in FIG. 4 additional tubes may be included within the outer tube 29. The inner tubes 33 and 35 can be interlocked with one another through the use of a locking mechanism. The tubes 33 and 35 may possess diameters different from one another. By interlocking the inner tubes 33 and 35 with different diameters and certain geometry such as, for example, the addition of the inner tube 34, an undesirable increased temperature at the radiant tube end of the radiant tube 31 can be reduced. Note that in some embodiments, the inner tubes 33, 34, 35, etc., may function as flame tubes.

FIG. 5 illustrates a schematic diagram of an example of a radiant tube 51 with three additionally installed interlocking tubes in the radiant tube 51, in accordance with an embodiment. The radiant tube 51 shown in FIG. 5 includes a number of the same features of the tube 31 shown in FIG. 3 and FIG. 4, for example, but with the addition of a configuration of three interlocking tubes 34, 64, and 66.

FIG. 6 illustrates a schematic diagram of an example radiant tube 61 with additionally installed not interlocking tubes in the radiant tube 61, in accordance with an embodiment. The configuration depicted in FIG. 6 includes the same features from FIG. 5 but with at least some of the tubes 64 and 66 in an arrangement in which one or more of the tubes is not interlocked.

The tubular design shown in, for example, the embodiments of FIG. 4 through FIG. 6 can address problems associated with heating industrial furnaces that operate with conventional radiant tubes. This is the problem of high temperature uniformity of tube surface required in order to be able to build furnaces that are compact and inexpensive to construct and operate. These nonuniformities of surface temperature are caused by the geometry of traditional inner flame tubes, by the direction change of the flue gas flow at the tube end, by the internal flue gas recirculation and by the very hot flame or, in case of flameless combustion, by the colder mixing zone and the hot reaction zone. The embodiments discussed herein can solve these problems by optimizing a radiant tube heating system through the use of interlocking tubes with different diameters and certain geometry to thereby reduce undesirable increased temperatures at the radiant tube end, as discussed herein.

Note that the term ‘uniformity’ as utilized herein and in the context of improving the uniformity of radiant tube temperature in a radiant tube heating system, can relate to the degree of consistency or even distribution of temperature along the length of the radiant tube. The term ‘uniformity’ can signify the absence of significant temperature variations or hot/cold spots within the tube.

In a radiant tube heating system, uniformity is crucial for ensuring efficient and effective heat transfer to the surrounding space. When the temperature is uniform, it means that the radiant heat emitted by the tube is evenly distributed, providing consistent and comfortable heating throughout the desired area. Achieving uniformity in radiant tube temperature can involve minimizing temperature gradients or variations along the length of the tube. This can be accomplished through careful design considerations such as disclosed herein, including proper sizing and positioning of the radiant tubes, effective burner control, and regular maintenance of the system. By improving uniformity, the radiant tube heating system can provide more consistent and balanced heat distribution, enhancing comfort and energy efficiency.

Furthermore, the terms ‘optimized’ and related terms such as ‘optimizing’ and ‘optimized’ and variations thereof as utilized herein and in the context of a radiant tube heating system for optimizing the system through the use of interlocking tubes with different diameters and certain geometry to reduce undesirable increased temperatures at the radiant tube end, relate to the state or condition in which a radiant tube heating system has been improved or adjusted to achieve the best possible performance, efficiency, or desired outcome. The term optimization can involve making changes or implementing strategies that maximize the benefits or advantages of the system while minimizing any drawbacks or inefficiencies. The term ‘optimizing’ may denote the active process of making modifications, adjustments, or improvements to a radiant tube heating system to enhance its performance, efficiency, or functionality. Optimizing can involves analyzing the existing system, identifying areas for improvement, and implementing changes to achieve the desired goals. The term ‘optimized’ may describe a radiant tube heating system that has undergone the process of optimization and has been adjusted or designed to operate at its highest level of efficiency or effectiveness. An optimized system can be described as a system that has been fine-tuned to minimize inefficiencies, improve performance, and achieve the desired outcome, such as reducing increased temperatures at the radiant tube end in this case.

In the context of interlocking tubes with different diameters and specific geometry, optimizing the radiant tube heating system may involve carefully designing—for example, also with fluid flow and thermal calculation (CFD)—the tube configuration to promote more balanced heat distribution, reduce temperature variations, and mitigate undesirable increased temperatures at the end of the tube. A goal is to find an optimized arrangement of interlocking tubes that can effectively distribute heat evenly and efficiently throughout the system, resulting in improved overall performance and enhanced thermal comfort.

Based on the foregoing, it can be appreciated that a number of different embodiments are disclosed herein. For example, in an embodiment a radiant tube apparatus, can include a burner and an inner flame tube. and at least one flow body can be installed in an area at an end of the inner flame tube opposite the burner.

In an embodiment, the at least one flow body may be tubular in shape.

In an embodiment, the at least one flow body can protrude into the flame tube.

In an embodiment, the at least one flow body can protrude into the flame tube with a length of approximately 0 to 1× diameter of the flame tube.

In an embodiment, the at least one flow body can protrude into the flame tube with a length of approximately 0.3 to 0.7× diameter.

In an embodiment, the at least one flow body can be arranged in an area at an end of the without overlap.

In an embodiment, the at least one flow body can comprise a polygonal tube-like body.

In an embodiment, the at least one flow body can comprise an arrangement of a plurality of polygonal tube-like bodies.

In an embodiment, each polygonal tube-like body among the plurality of polygonal tube-like bodies can be located next to each other, behind each other, or inside each other.

In an embodiment, a plurality of flow bodies can be provided for the displacement of flow including the at least one flow body, wherein the flow bodies among the plurality of flow bodies can be individually or mostly partially or completely closed therein.

In an embodiment, a radiant tube apparatus can include a burner and an inner flame tube, and at least one flow body installed in an area at an end of the inner flame tube opposite the burner, wherein the at least one flow body is tubular and protrudes into the flame tube.

In an embodiment, a radiant tube apparatus can include a burner and an inner flame tube; and at least one flow body installed in an area at an end of the inner flame tube opposite the burner, wherein the at least one flow body is tubular and protrudes into the flame tube, wherein the at least one flow body is arranged in an area at an end of the without overlap.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A radiant tube apparatus, comprising:
a burner and an inner flame tube; and
at least one flow body installed in an area at an end of the inner flame tube opposite the burner.

2. The radiant tube apparatus of claim 1 wherein the at least one flow body is tubular.

3. The radiant tube apparatus of claim 1 wherein the at least one flow body protrudes into the flame tube.

4. The radiant tube apparatus of claim 1 wherein the at least one flow body protrudes into the flame tube with a length of approximately 0 to 1× diameter of the flame tube.

5. The radiant tube apparatus of claim 1 wherein the at least one flow body protrudes into the flame tube with a length of approximately 0.3 to 0.7× diameter.

6. The radiant tube apparatus of claim 1 wherein the at least one flow body is arranged in an area at an end of the without overlap.

7. The radiant tube apparatus of claim 1 wherein the at least one flow body comprises a polygonal tube-like body.

8. The radiant tube apparatus of claim 1 wherein the at least one flow body comprises an arrangement of a plurality of polygonal tube-like bodies.

9. The radiant tube apparatus of claim 8 wherein each polygonal tube-like body among the plurality of polygonal tube-like bodies are located next to each other, behind each other, or inside each other.

10. The radiant tube apparatus of claim 8 further comprising a plurality of flow bodies for the displacement of flow including the at least one flow body, wherein the flow bodies among the plurality of flow bodies are individually or mostly partially or completely closed therein.

11. A radiant tube apparatus, comprising:
a burner and an inner flame tube; and
at least one flow body installed in an area at an end of the inner flame tube opposite the burner, wherein the at least one flow body is tubular and protrudes into the flame tube.

12. The radiant tube apparatus of claim 11 wherein the at least one flow body is arranged in an area at an end of the without overlap.

13. The radiant tube apparatus of claim 11 wherein the at least one flow body comprises a polygonal tube-like body.

14. The radiant tube apparatus of claim 11 wherein the at least one flow body comprises an arrangement of a plurality of polygonal tube-like bodies.

15. The radiant tube apparatus of claim 14 wherein each polygonal tube-like body among the plurality of polygonal tube-like bodies are located next to each other, behind each other, or inside each other.

16. The radiant tube apparatus of claim 14, further comprising a plurality of flow bodies for the displacement of flow including the at least one flow body, wherein the flow bodies among the plurality of flow bodies are individually or mostly partially or completely closed therein.

17. A radiant tube apparatus, comprising:
a burner and an inner flame tube; and
at least one flow body installed in an area at an end of the inner flame tube opposite the burner, wherein the at least one flow body is tubular and protrudes into the flame tube, wherein the at least one flow body is arranged in an area at an end of the without overlap.

18. The radiant tube apparatus of claim 17 wherein the at least one flow body comprises a polygonal tube-like body.

19. The radiant tube apparatus of claim 17 wherein the at least one flow body comprises an arrangement of a plurality of polygonal tube-like bodies, and wherein each polygonal tube-like body among the plurality of polygonal tube-like bodies are located next to each other, behind each other, or inside each other.

20. The radiant tube apparatus of claim 17 further comprising a plurality of flow bodies for the displacement of flow including the at least one flow body, wherein the flow bodies among the plurality of flow bodies are individually or mostly partially or completely closed therein.
